(19) United States
(12) Patent Application Publication
(10) Pub. No.: US 2011/0054981 A1
(43) Pub. Date: Mar. 3, 2011

(54) Analyzing Local Non-Transactional Data with Transactional Data in Predictive Models

(76) Inventors: Patrick L. Faith, Pleasanton, CA (US); Kevin P. Siegel, Milpitas, CA (US)

(21) Appl. No.: 12/614,603

(22) Filed: Nov. 9, 2009

Related U.S. Application Data
(60) Provisional application No. 61/237,394, filed on Aug. 27, 2009.

(51) Int. Cl. G06Q 30/00; G06Q 99/00; G06Q 10/00; G06Q 50/00

(52) U.S. Cl. 705/10; 705/1.1; 705/14.25; 705/14.66

(57) ABSTRACT

Systems and methods are provided that empowers various parties to combine transactional data and local non-transactional data using the collective intelligence gathered from a variety of sources to help the parties make more intelligent decisions relating to consumers. For example, the system can help select consumers based on the probability that the consumers will take advantage of an offer, coupon, or other item. In some embodiments, the present invention can be deployed as a part of a system that processes transactions. In this system, information associated with the transactions is analyzed in conjunction with non-transactional data in order to probabilistically determine whether a further action should be taken with the consumer.

This application claims the benefit of U.S. Provisional Application No. 61/237,394, filed Aug. 27, 2009, hereby incorporated by reference in its entirety for all purposes.

### BACKGROUND

Many systems exist for analyzing transactional data in order to attempt to determine various characteristics of a consumer. For example, a consumer's spending habits on a credit card might be analyzed to determine whether the consumer has a history of purchasing a particular class of items from certain retailers. One consumer may frequently purchase DVDs, while another consumer may regularly purchase cosmetics. This information can then be used help decide whether to take a certain course of action with a consumer. For example, a consumer who frequently purchases DVDs may buy even more DVDs if the consumer is made aware of new DVD releases or promotions relating to DVDs. It may be profitable for a movie studio to identify such a consumer and send the consumer coupons for DVDs, notifications of new DVD releases, or other information that might help generate sales for the movie studio.

While transactional data is useful for analyzing the spending behavior of consumers, there are many other sources of data that could be also used to help determine which consumers might make good candidates for a wide variety of actions. For example, a consumer who is a movie aficionado may not be aware of a classic movie festival taking place in the same city as the consumer. The movie festival may be announced in a newspaper or other similar medium, but this information is generally stored in completely different systems than transactional data that might traditionally be analyzed. Transactional data analysis systems generally have no way to efficiently and effectively combine transactional data that can be used to identify consumers with other data from non-transactional sources that can be used to identify relevant events that the consumers may be interested in. As a result, systems that analyze transactional data are often not taking full advantage of easily accessible information to make better decisions relating to consumers.

Hence, it would be desirable to provide a method and system that is capable of providing a more robust consumer analysis using data that goes beyond using transactional data.

### BRIEF SUMMARY

Various embodiments of the present invention combine transactional data and local non-transactional data in order to probabilistically determine whether various courses of action should be taken with a consumer.

According to one embodiment, a method for using transactional data and local non-transactional data is disclosed. The method receives transactional data at a server computer, wherein the transactional data relates to transactions conducted by a consumer. The method also receives local non-transactional data at the server computer. The transactional data and the local non-transactional data are analyzed using the server computer, and then further processing is performed after analyzing the transactional data and the local non-transactional data.

According to another embodiment, a system for combining transactional data and local non-transactional data to take an action with a consumer is disclosed. The system comprises a transactional data receiver that is configured to receive transaction data relating to transactions conducted by a consumer. The system also comprises a local data receiver that is configured to receive local non-transactional data. The system may also comprise a data analyzing module that is configured to analyze transactional data received by the transactional data receiver with the local non-transactional data received at the local data receiver. The system may also comprise an action initiating module that is configured to perform further processing after the analysis of the transactional data and the local non-transactional data.

Many additional embodiments, such as computer-readable comprising computer-executable code for carrying the methods described herein are also disclosed.

### BRIEF DESCRIPTION

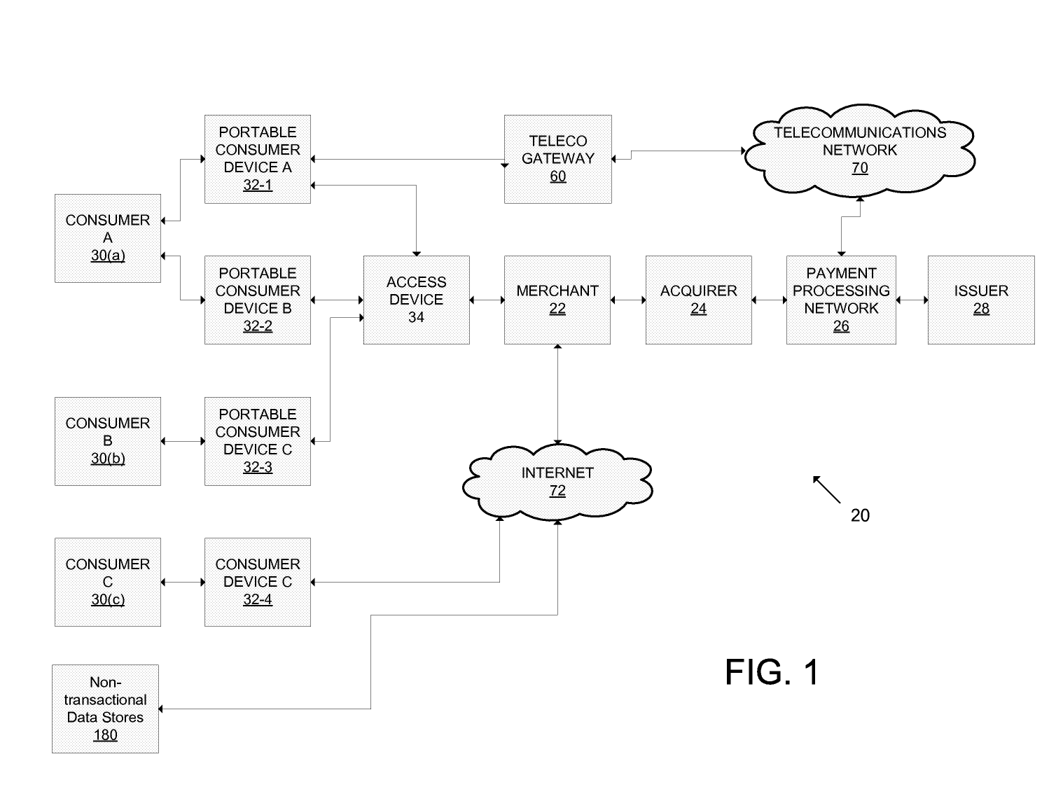

FIG. 1 shows a block diagram of a system that can be used in some embodiments of the invention.

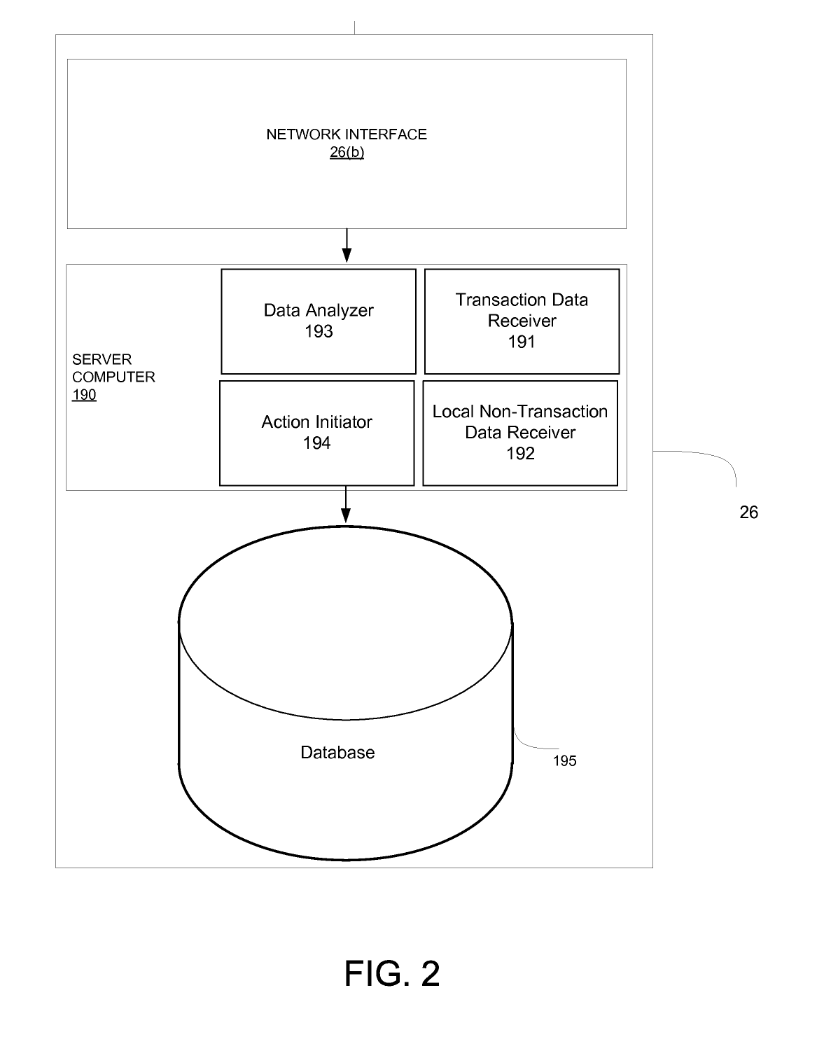

FIG. 2 shows a diagram of a server computer and some components of the server computer according to an embodiment of the invention.

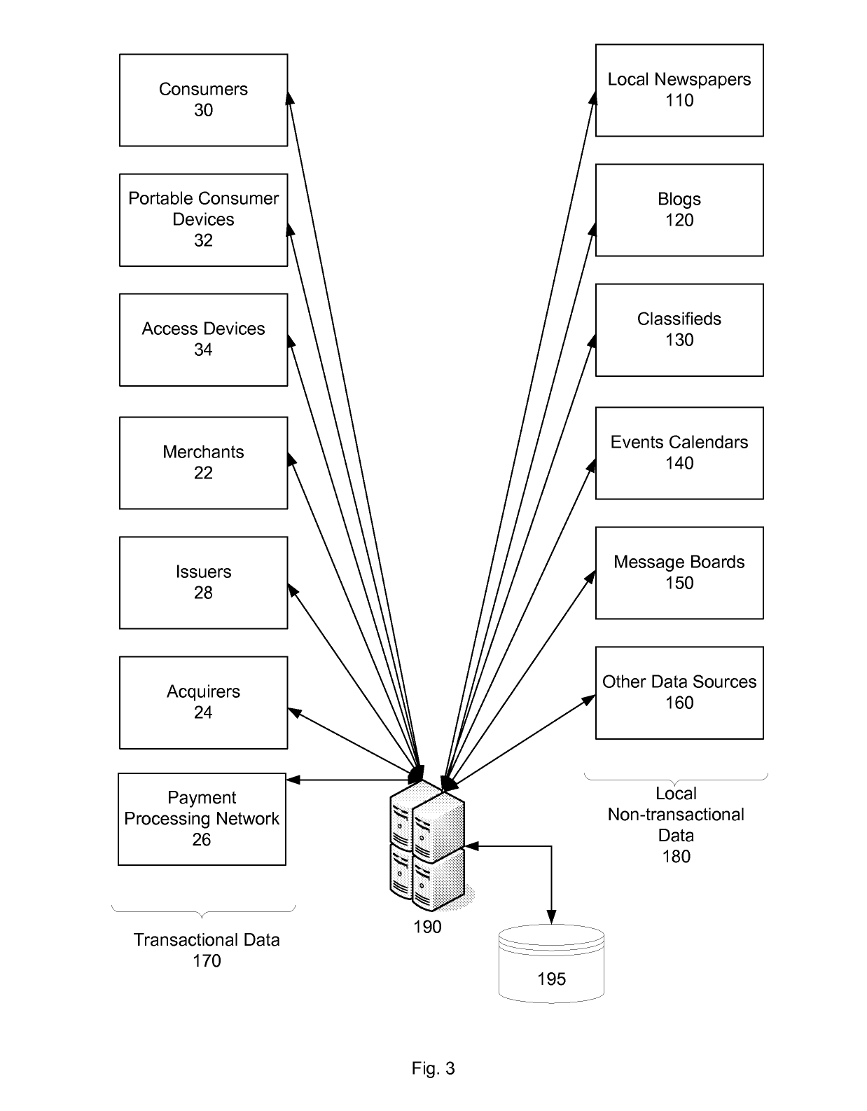

FIG. 3 is an illustration of how transactional data and non-transactional data can be combined according to an embodiment of the invention.

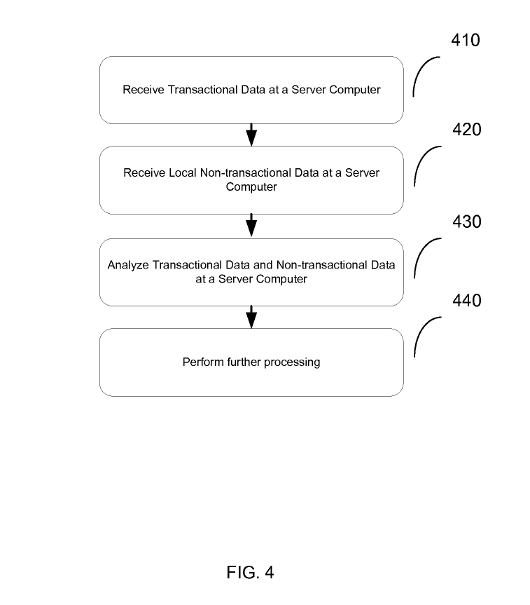

FIG. 4 is a flow chart illustrating a process according to an embodiment of the invention.

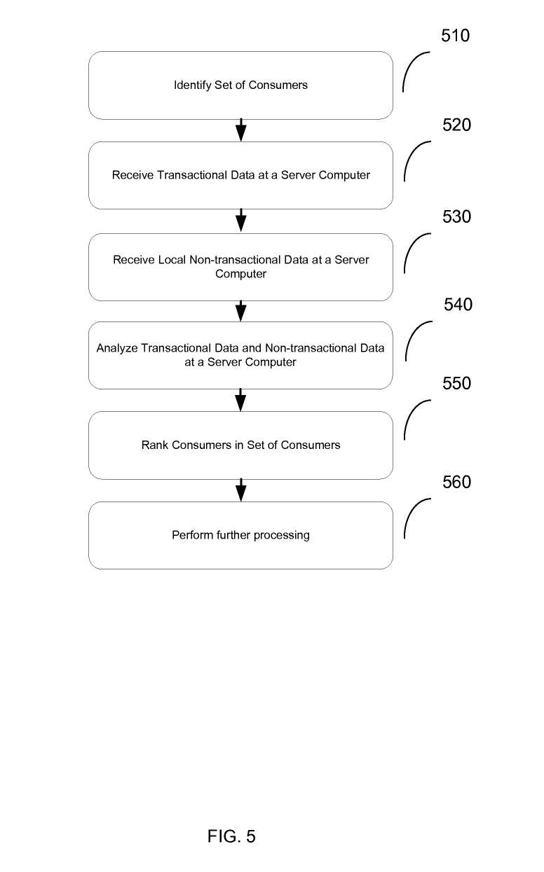

FIG. 5 is a flow chart illustrating a process according to an embodiment of the invention.

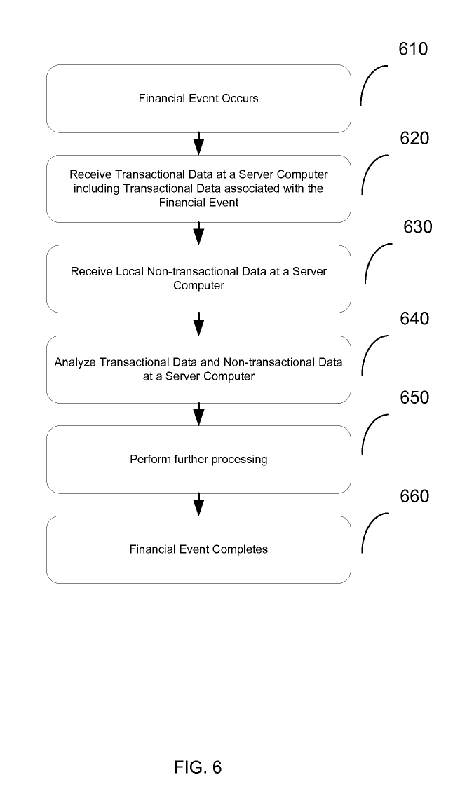

FIG. 6 is a flow chart illustrating a process according to an embodiment of the invention.

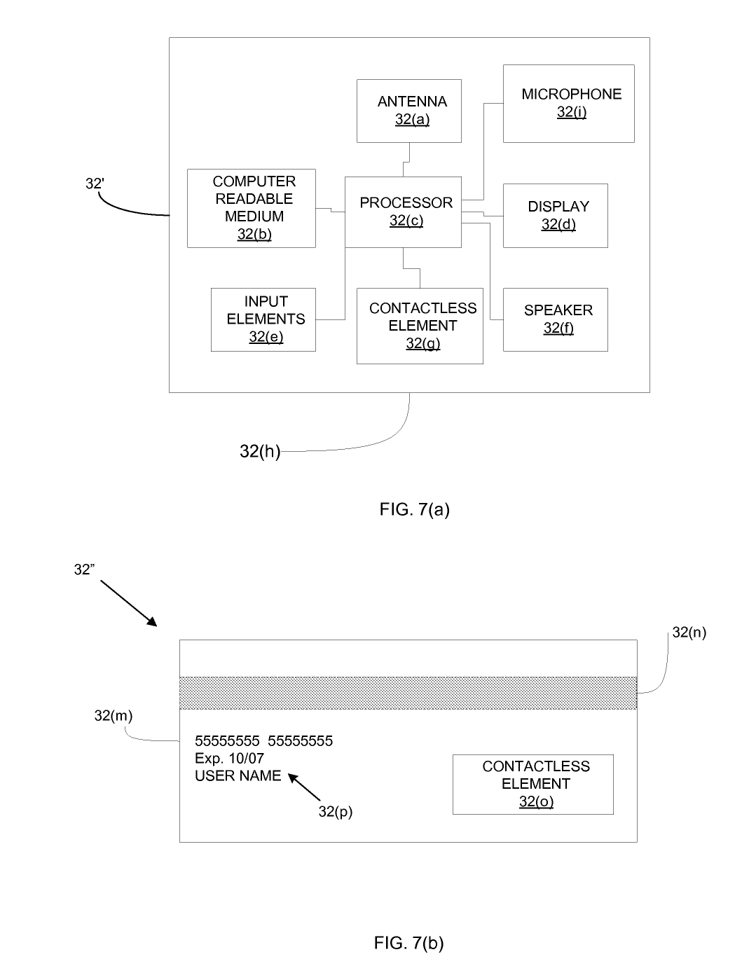

FIG. 7(a) shows a block diagram of a consumer device in the form of a phone.

FIG. 7(b) shows an illustration of a payment card.

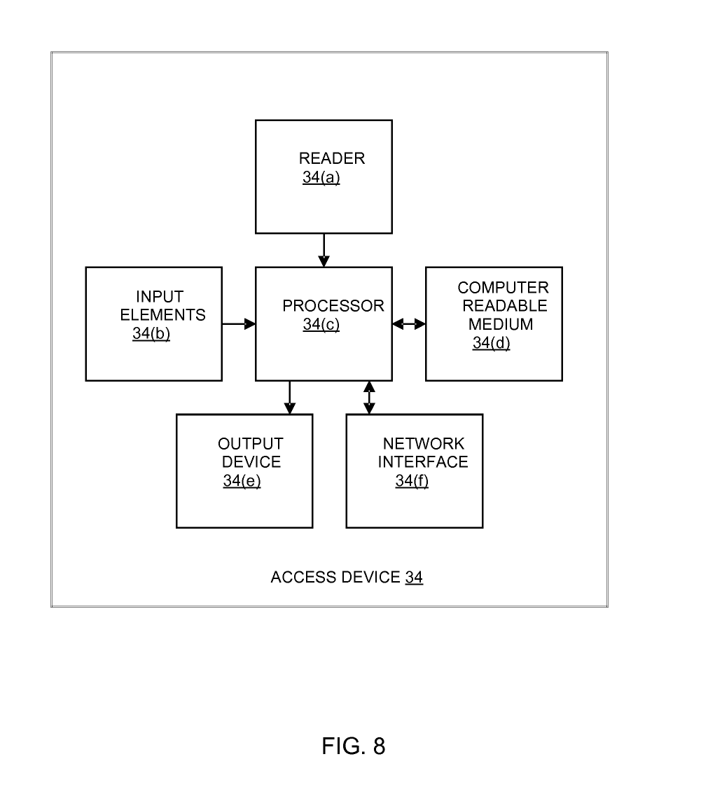

FIG. 8 shows a block diagram of an access device according to an embodiment of the invention.

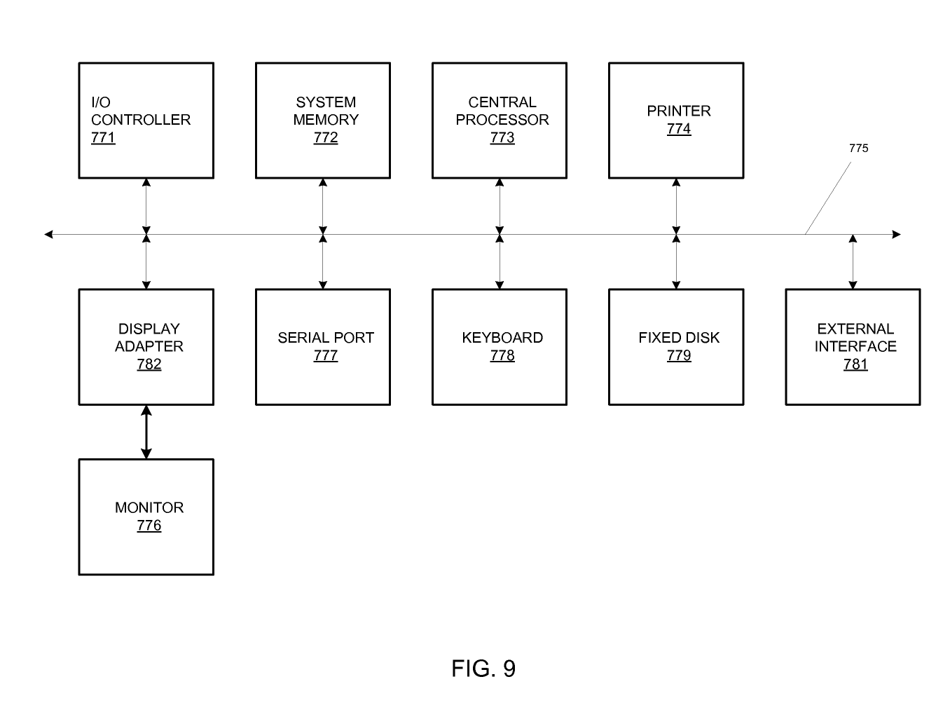

FIG. 9 shows a block diagram of a computer apparatus.

### DETAILED DESCRIPTION

The present invention in the form of one or more exemplary embodiments will now be described. In one exemplary embodiment, a system is provided that empowers various parties to combine transactional data and local non-transactional data in order to use the collective intelligence gathered from a variety of sources to help the parties make more intelligent decisions relating to consumers. For example, a payment card service association, such as Visa, can use the system to help select specific consumers out of a large set of consumers for a further action. For example, the system can help select consumers based on the probability that the consumers will take advantage of an offer or a coupon. In alternative embodiments, the present invention can be deployed as a part of a system that processes transactions. In this system, information associated with the transactions is analyzed in conjunction with non-transactional data in order to probabilistically determine whether a further action should be taken with the consumer. Based on the disclosure and teachings provided herein, a person of ordinary skill in the art will appreciate other ways and/or methods to deploy the present invention.

Although many of the embodiments below describe how transactional data and local non-transactional data can be used to help select consumers as targets for various promotional purposes, similar processes can act upon similar data to help make other decisions relating to consumers. For example, a risk prediction model could be created from transactional and non-transactional data that can help determine the probability of whether a transaction conducted by a consumer is fraudulent. For example, the non-transactional data might include information from a local newspaper regarding a recent increase in crime in a given neighborhood, and transactions conducted in the neighborhood may have a greater chance of being fraudulent. Similarly, non-transactional data might be useful for analyzing other types of risk, such as credit risk or bankruptcy risk. Embodiments of the invention are flexible enough to implement a wide variety of applications.

In one embodiment, the system of the present invention is able to analyze all or substantially all of the authorization request messages received from multiple merchants (or their respective acquirers) with local non-transactional data. “Substantially all” can include a significant percentage (e.g., 90-99%), and authorization request messages may be one type of transactional data. Furthermore, analysis can be performed in-flight as part of the authorization process, thereby minimizing impact on the authorization process. The architecture of the system that allows it to evaluate every authorization request in-flight can be based upon a distributed environment. The distributed environment can use a hybrid approach or infrastructure that combines multiple evaluation technologies across separate platforms. This architecture can be designed to take advantage of the strengths of different techniques so as to maximize the accuracy and robustness of various evaluation models. Additional details on the architecture and the distributed environment of the system can be found in U.S. Pat. Nos. 6,119,103, 6,018,723, 6,658,393, 6,598,030, and 7,227,950, which are herein incorporated by reference in their entirety for all purposes.

For the purposes of this disclosure, non-transactional data may refer to data that is generally not related to the process of authorizing, clearing, or settling a transaction that is conducted between a consumer and a merchant. An exemplary transaction may be conducted using a payment card such as a debit, credit, or prepaid card. Non-transactional data can include data extracted from articles in local newspapers, posts on blogs, classified ads, event calendars, posts on message boards, or other similar data that is not typically related to a transaction between a consumer and merchant.

Transactional data, on the other hand, may include data such as the consumer's personal account number and expiration date, which are used to authorize a transaction that is being conducted. Other data that might relate to a transaction includes information about the items being purchased, the total amount to be charged to the consumer's account, information about the merchant, and other similar data. Transactional data may also include data such as an IP address, timestamp, or other security codes in the transaction. More details on transactional data and non-transactional data will be given later in this disclosure.

I. Exemplary Systems

A system according to an embodiment of the invention is shown in FIG. 1.

FIG. 1 shows a system 20 that can be used in an embodiment of the invention. The system 20 includes a merchant 22 and an acquirer 24 associated with the merchant 22. In a typical payment transaction, a consumer 30(a) may purchase goods or services at the merchant 22 using a portable consumer device such as portable consumer device A 32-1. The consumer may be an individual, or an organization such as a business that is capable of purchasing goods or services. The acquirer 24 can communicate with an issuer 28 via a payment processing network 26.

As used herein, an “issuer” is typically a business entity (e.g., a bank) that maintains financial accounts for the consumer and often issues a portable consumer device, such as a credit or debit card, to the consumer. A “merchant” is typically an entity that engages in transactions and can sell goods or services. An “acquirer” is typically a business entity (e.g., a commercial bank) that has a business relationship with a particular merchant or other entity. Some entities can perform both issuer and acquirer functions. Embodiments of the invention encompass such single entity issuer-acquirers.

In FIG. 1, consumers A 30(a), B 30(b), and C 30(c) are illustrated. In some embodiments, the consumers 30 can use at different types of consumer devices to make purchases and/or to interact with the various service providers. In FIG. 1, the consumer 30(a) has a portable consumer device A 32-1 and a portable consumer device B 32-2. Consumer B 30(b) has a portable consumer device C 32-3, and consumer C 30(c) has a consumer device C 32-4. The consumer device A 32-1 may be a phone. The consumer device A 32-1 may consequently be used to communicate with the issuer 28 via a telecommunications gateway 60, a telecommunications network 70, and a payment processing network 26. The portable consumer device B 32-2 may be a card such as a credit card. The consumer device 32-4 may be a personal computer that is used to communicate with the merchant 22 and other parties including the merchant 22, the payment processing network 26, and the issuer 28 via the Internet 72. The different consumer devices A, B, and C may be linked to the same issuer account numbers or different issuer account numbers.

As illustrated above, the consumer devices according to embodiments of the invention may be in any suitable form. In some embodiments, the consumer devices are portable in nature and may be portable consumer devices. Suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card). In some embodiments, the consumer devices are not dedicated loyalty instruments.

Each consumer device may comprise a body and a memory comprising a computer readable medium disposed on or within the body. The computer readable medium may comprise code for a form factor indicator element coupled to the body. The form factor indicator element may be in a form factor indicator tag. The computer readable medium may also comprise code for one or more customer exclusive data tags (described above). In addition, the consumer device may also include a processor coupled to the memory, where greater functionality and/or security are desired.

Other types of consumer devices may include devices that are not generally carried by consumers to make purchases. An example of a consumer device of this type may be a desktop or laptop computer.

The payment processing network 26 may include data processing subsystems, networks, and operations used to support and deliver authorization services, exception file services, and clearing and settlement services. For example, referring to FIG. 2, the payment processing network 26 may comprise a server computer 190, coupled to a network interface 26(b), and a database of information 195. According to various embodiments, server computer 190 may also have various modules within it. For example, in FIG. 2, server computer 190 is shown with a data analyzer 193, transaction data receiver 191, action initiator 194, and local non-transaction data receiver 192. These modules may be implemented as software and can direct the processor of the server computer 190 to carry out various instructions. More details on the functionality provided by modules, such as the ones illustrated in FIG. 2, will be given in more detail later in this disclosure.

An exemplary payment processing network 26 may include VisaNet™ Payment processing networks such as VisaNet™ are able to process credit card transactions, debit card transactions, and other types of commercial transactions. VisaNet™, in particular, includes a VIP system (Visa Integrated Payment system) which processes authorization requests and a Base II system which performs clearing and settlement services.

As noted above, the payment processing network 26 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 26 may use any suitable wired or wireless network, including the Internet.

The merchant 22 may also have, or may receive communications from, an access device 34 that can interact with the portable consumer device 32. The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device 34 is a point of sale terminal, any suitable point of sale terminal may be used including card readers. The card readers may include any suitable contact or contactless mode of operation. For example, exemplary card readers can include RF (radio frequency) antennas, magnetic stripe readers, etc. to interact with the portable consumer devices 32.

Also shown in FIG. 1 is an example of non-transactional data stores 180. As illustrated in FIG. 1, non-transactional data stores 180 may be accessible over the Internet 72, but various embodiments may allow for many different means for accessing the non-transactional data stores 180. Non-transactional data stores 180 can be found in a wide variety of forms. Many non-transactional data stores 180 can be in the form of a server computer that communicates with clients over the Internet 72. For example, a non-transaction data store may be in the form of a website. The website could serve data for a newspaper, blog, classified ad, sales listing, events calendar, message board, or any other type of information commonly found on the Internet 72. Alternatively, some non-transactional data stores 180 may use other means to communicate their data to clients. Typically, a non-transactional data store 180 is created by a party not normally involved in a transaction between a consumer and a merchant, and a non-transactional data store 180 is typically created for reasons other than taking part in a process related to a transaction.

The data managed by non-transactional data stores can be accessed or retrieved in a number of different ways. For example, various embodiments may subscribe to non-transactional data stores using well-known methods such as RSS (“Really Simple Syndication”) feeds. Other similar subscription technologies supported by non-transactional data stores may also be used, such as subscribing to an email list managed by a non-transactional data store 180. Data may also be obtained from non-transactional data stores 180 on a more active basis. For example, modules may use a web crawler or other similar means for obtaining data from non-transactional data stores 180.

FIG. 3 is an illustration of how transactional data 170 and non-transactional data 180 can be combined according to an embodiment of the invention.

Transactional Data 170 can be acquired from any of the transactional related components illustrated in system 20 illustrated in FIG. 1. As shown in FIG. 3, transactional data 170 can come from sources such as consumers 30, portable consumer devices 32, access devices 34, merchants 22, issuers 28, acquirers 24, or payment process network 26. Other similar sources can also be used to acquire transactional data.

Non-Transactional Data 180 can also come from a wide variety of sources. As illustrated in FIG. 3, sources of non-transactional data may include local newspapers 110, blogs 120, classifieds 130, event calendars 140, message boards 150, or other similar sources 160 of non-transactional data.

Also illustrated in FIG. 3 is a server computer 190 coupled with database 195. Server computer 190 and database 195 may be the same as server computer 190 and database 195 illustrated in FIG. 2. Server computer 190 may have many different modules capable of performing various tasks for the server computer 190 related to the transactional 170 and non-transactional 180 data. For example, server computer 190 may have a transactional data receiver 191 configured to receive transactional data 170 from the transactional data sources illustrated in FIG. 3. Similarly, server computer 190 may have a local non-transaction data receiver 192 configured to receive non-transactional data 180 from non-transactional data sources. Once data is retrieved from these various sources, the data can be stored in database 195 for further processing.

As will be described in relation to the exemplary methods section of this disclosure, transactional data and non-transactional data can be used to create various data models related to consumers. According to one embodiment, a module such as a data analyzer 193 may be used to help create data models. Data models can then be used to make various probabilistic determinations related to the consumers. A module such as a data analyzer 193 may also be used for to make these probabilistic determinations. Probabilistic determinations can then be used to decide a variety of courses of action that can be taken with the consumers. According to one embodiment, a module such as an action initiator 194 may be used to take an action with a consumer. Although various modules are describes as having specific tasks within the server computer, one skilled in the art will recognize that other logical divisions of labor could be used to create one or more modules that accomplish the same functions as the modules described above.

II. Exemplary Methods

Methods according to embodiments of the invention can be described with respect to FIGS. 4 and 6. These methods can be implemented at any of the devices or entities illustrated in FIG. 1. According to some embodiments, the methods are executed in a distributed manner so that multiple entities participate in the method. For the purposes of describing these methods, FIGS. 4-6 will describe the processes as if they were occurring on a server computer managed by a payment processing network 26.

FIG. 4 is a flow chart illustrating a process according to an embodiment of the invention. More specifically, FIG. 4 illustrates the general process used to combine transactional and non-transactional data to take an action with a consumer.

At step 410, transactional data is received at a server computer. As previously explained, transaction data can be generated from a variety of sources during the course of a conducting a transaction between a consumer and a merchant. According to some embodiments, transactional data can be received from an ongoing transaction or other financial event. According to some embodiments, transactional data can be retrieved from an archive of past transactions. Archived transactions may be stored in a database for later use. According to some embodiments, a module such as a transaction data receiver 191 may be used to receive the transactional data.

In embodiments of the invention, the transaction data is typically generated from transactions that are conducted by the consumer or other consumers using one or more portable consumer devices. For example, referring to FIG. 1, consumer A 30(a) may use two portable consumer devices A 32-1 and B 32-2 (which may be associated with the same or different issuers) such as a debit card and a credit card to conduct transactions. When the 30(a) consumer conducts transactions using the consumer devices A 32-1 and B 32-2, they may interact with the access device 34 at a merchant 22. The access device 34 may generate authorization request messages comprising information such as the amount of any transactions, the names or merchant category codes of any merchants involved, account numbers, etc. which may pass to the issuer 28 via the acquirer 24 and the payment processing network 26. The issuer 28 may approve or deny the authorization request messages, and may send authorization response messages back to the access device 34 via the payment processing network 26 and the acquirer 24. At the end of the day or other time period, a clearing and settlement process takes place between the acquirer 24, payment processing network 26, and the issuer 28. Any of the data (e.g., merchant codes, purchase amounts, approval or decline information, etc.) associated with such transactions can be captured by the payment processing network 26 and can be used as transaction data in embodiments of the invention.

The payment processing network 26 (and any server residing therein) advantageously resides between multiple issuers (not shown) and acquirers and merchants, so that virtually all electronic payment transactions conducted by the consumer are captured, regardless of which payment devices or accounts the consumer chooses to use. This advantageously provides the system with a very clear picture of the consumer's purchasing behavior as compared to the case where consumer data associated with only one merchant or only one payment device is used for transaction data. More accurate and more relevant transaction data results in more accurate and more relevant additional processing when it is combined with localized non-transaction data.

According to some embodiments, transactional data can be converted into keys that can be used as inputs into a predictive model. In one embodiment, software modules can generate features for keys associated with the transactional data and a series of values associated with these keys. The values may include, but are not limited to, probabilities associated with the keys. A key is a structure used to group information from a transaction. For instance, a key can represent an account number, an individual transaction within the account, a location, an issuer, an amount, or various status fields within a transaction. Additional details relating to keys and feature generation can be found in U.S. Pat. No. 7,227,950.

At step 420, non-transactional data is received at a server computer. As previously explained, non-transactional data can be received from a variety of different sources using a variety of different communication means. Non-transactional data, similarly to the transactional data, can be aggregated and archived for later use. Also, non-transactional data can also be represented as keys that can be used as the inputs into a probabilistic predictive model. Non-transactional keys can represent things such as the geographic location of a news event, the date of an event from an events calendar, the name of a performer for an upcoming concert, etc. According to some embodiments, a local non-transaction data receiver 192 may be used to receive the non-transactional data.

According to various embodiments, the non-transactional data received contains data that is “local” non-transactional data. Local non-transactional data refers to non-transactional data that attempts to capture information about local events, as opposed to national or world events. For example, for the purposes of combining non-transactional data with transactional data, it may often be useful to receive non-transactional data that informs a probabilistic predictive model that an art fair is taking place in a given town or neighborhood. Non-transactional data that informs a probabilistic predictive model of world events, such as the fact that an election is taking place in Great Britain, will likely not lead to useful outcomes when used in a probabilistic predictive model. Local non-transactional data has a higher probability of providing information that may yield useable information when combined with transactional data.

The local data that is used in embodiments of the invention may come from a local source of information such as a local newspaper or local blog. Local data from a national source (e.g., the national news reporting on a local event) is less reliable and less unique, because everyone is presumed to know about it. On the other hand, local data from a local source is more likely to embody more accurate information.

The non-transaction data may be localized in any suitable manner. For example, in some embodiments, localized data may be data relating to events (e.g., news) that are occurring within 20, 50, or 100 miles from where a consumer resides and/or works. In other embodiments, the localized data may relate to events that are occurring only within the zip code (and/or in zip codes directly adjacent to the zip code) in which the consumer resides and/or works. For example, a sale on office supplies in a local newspaper by a merchant located in the consumer's home town would be an example of localized non-transaction data. As noted above, non-transaction data that is not localized (e.g., national news) with respect to the consumer may not produce a useful result when combined with transaction data associated with the consumer, since non-localized data is very general.

In order to increase the amount of local non-transactional data received, non-transactional data sources that contain a higher amount of local non-transactional data may be targeted. For example, the front page of a large daily national newspaper, such as the New York Times, will likely not contain as much local non-transactional data as a small town local newspaper that publishes once a week. However, even a newspaper like the New York Times may contain some useful local non-transactional data for combining with transactional data in sections such as the classified ads. Similarly, a blog that contains posts related to national or world politics is less likely to yield useful non-transactional data than a blog that is primarily concerned with new wines that the blogger has purchased from local wine shops. Various non-transactional data sources can be weighted based on the amount of useful local data they provide.

The “local” nature of non-transaction data can be determined in any number of ways. For example, the word count of locations in a newspaper article can help determine the relevant local area of the story. Information about the circulation of the newspaper can also be used to determine the likely intended audience of the non-traditional data source. Other types of data sources can have their local nature determined using similar mechanisms. One skilled in the art will recognize that there are many different ways to determine this aspect of the non-traditional data.

At step 430, the transactional data and the non-transactional data are analyzed at a server computer. In one embodiment, software modules use hybrid predictive modeling to analyze the transactional and non-transactional data. The predictive modeling is performed based on a number of input parameters including, for example, information relating to a transaction and recent transaction histories. Additionally, the local non-transactional data can also be used as input parameters for the predictive modeling. For example, non-transactional data relating to upcoming concerts, promotions taking place at various merchants, and recent restaurant reviews can be used as input parameters. According to various embodiments, a module such as a data analyzer 193 may be used to analyze the transactional data and the non-transactional data. Additional details relating to predictive modeling are further described in U.S. Pat. Nos. 6,119,103, 6,018,723, 6,658,393, and 6,598,030.

The predictive model can then be analyzed to find potential items or events of interest for a consumer. The predictive model may be able to determine a consumer's spending habits from the consumer's transaction history. For example, one consumer may be a frequent purchaser of antiques. The predictive model may be able to determine this characteristic of the consumer by analyzing the merchants that the consumer has conducted transactions with and the items purchased by the consumer. Additionally, the predictive model may aware that an antique fair is taking place in a week near the consumer's residence because of non-transactional data that has been received. Alternatively, the predictive model may be aware of an antique fair that is taking place far from the consumer's residence, but nonetheless near the present location of the consumer. For example, the consumer may have recently conducted a transaction near the distant antique fair because the consumer is on a vacation. The consumer's transaction history and the local non-transactional data can thus be combined to determine that there is a high likelihood that the consumer would be interested in knowing about the antique fair. When a match such as this is discovered, further processing can occur to take advantage of the match.

Another example is one in which the user him or herself announces in a web log (blog) that he or she is about to be married. The predictive model can take this into consideration when a large purchase of wedding paraphernalia or supplies, such as $4,000 worth of flowers, are ordered by the consumer. Ordinarily, such a luxury expenditure may raise flags as an odd purchase. However, the predictive model can lower the risk score of such a transaction with the information that a wedding is imminent.

Yet another example is a purchase in which a delivery is to be made to a neighborhood in which there is a high foreclosure rate. Because a high foreclosure rate (e.g., greater than 10%, 20%, 30%) indicates many homes in the neighborhood may be unoccupied, the fact that an item is ordered to a house in the neighborhood can indicate that a stolen card is being used to order goods to be delivered to the front step of an unoccupied house. The thief, who ordered the merchandise, would then be able to retrieve the merchandise without being traced. Thus, a risk score can be increased for items ordered to be delivered to such a neighborhood.

Another example is for news from local advertisements or licensing departments to be used to determine a profession, which can then lead to decreased or increased risk scores for ordered merchandise. If a local advertisement indicates that a card holder is a licensed painter, then a purchase of painting supplies by the card holder is assigned a lower risk score.

According to one embodiment, modules within a server computer can use tumblers and locks to conduct the above analysis based on the predictive model. Tumblers and locks can be used to define the rules to create features in the models. For example, a lock structure is used to control the processing of a key. A probability threshold can be used to restrict the lock operation in use of the tumbler. If the probability value of a tumbler element does not meet the threshold of the lock, the element is ignored. A tumbler is an n-ary tree structure pre-configured with input key matches that are pre-encrypted and compressed. Input keys, such as the ones created from the transactional and local non-transactional data, can be used in conjunction with tumblers and locks to determine potential items of interest to a consumer. Keys can be processed by locks, which in turn may create additional keys that can be used for further processing with additional locks. Ultimately, potential items of interest with associated probabilities or scores can be identified using this system of keys, locks, and tumblers. Additional details relating to keys, tumblers, and locks can be found in U.S. Pat. No. 7,227,950.

At step 440, further processing is performed based on the analysis of the transactional and non-transactional data. According to various embodiments, an action initiator 194 can be used to conduct the further processing. The further processing may encompass a variety of actions. For example, a consumer might be sent an SMS message informing the consumer of the antique fair. Additionally, if the antique fair requires a ticket for admission, a coupon offering a discounted ticket price may be sent to the consumer. The coupon may be sent to the consumer via SMS, email, regular mail, or using any other appropriate communication means. Alternatively, a ticket may be sent to the consumer. According to some other embodiments, non-transactional data can be used to assist a consumer conducting a transaction. For example, there is a lower risk of fraudulent activity involving a consumer's account if the consumer has a history of purchasing antiques and a payment processing network is receiving authorization requests from an ongoing antique fair.

FIG. 5 is a flow chart illustrating a process according to an embodiment of the invention. More specifically, FIG. 5 illustrates a process that can be used to identify consumers from a set of consumers that may be interested in a particular item or event in an offline manner. For example, an issuer may wish to determine which of its current account holders may be interested in taking advantage of a new promotional credit card that offers discounts on purchases made at a particular retailer of consumer electronics. This type of analysis can be conducted offline (i.e., not in real-time with an ongoing financial event).

At step 510, a set of consumers is identified. The initial set of consumers may be identified based on the particular analysis about to be conducted. For example, if an issuer wants to identify consumers that might be interested in a new promotional offer by the issuer, the initially identified consumers might be the present consumers holding accounts with the issuer.

At steps 520 and 530, similar to steps 410 and 420, transactional data and local non-transactional data are received at a server computer. The transactional data may be the transactional data related to the selected consumers. The local non-transactional data may be data related to the purposes of the analysis. Continuing with the example of an analysis that is trying to identify consumers that may be interested in a new promotional credit card that offers discounts at a particular retailer, transactional data related to previous purchases made at the retailer may be useful. Additionally, transactional data related to purchases of the same kind of goods that the retailer sells might be useful. Useful local non-transactional data may include information such as the geographic location of branches of the retailer, announcements of new branches of the retailer that have recently opened, or even announcements or reviews of new products that the retailer may sell.

At step 540, similar to step 430, the transactional and non-transaction data are analyzed together. For example, the data can be analyzed in order to probabilistically identify consumers that may be interested in taking advantage of the offer of the new promotional credit card. The analysis may determine that the consumers with the highest probability of taking advantage of the offer may be the consumers that have purchased a large amount of consumer electronics, shop at the retailer (or the retailer's competitors), and also live close to branches of the retailer. More detailed data may also be helpful in the analysis. For example, consumers that frequently purchase action movies on DVD may be more likely to take advantage of the promotional offer if a new box set of Arnold Schwarzenegger movies is scheduled to be released in a few weeks.

At step 550, the identified consumers are ranked. According to some embodiments, the output of the analysis is a score value that relates to the objective of the analysis. According to some embodiments, the score values are related to the probability that a consumer will be interested in an offer. A consumer with a score value higher than another consumer may mean that the consumer has a higher likelihood of being interested in the offer.

At step 560, similar to step 440, further processing is performed. For example, an issuer requesting the analysis might only wish to mail an offer for the new promotional credit card to the top 1000 consumers. Another issuer might want to only target the top 25% of their consumers. An issuer may also take different actions for different consumers depending on where the consumers rank. For example, consumers that rank in the top 10% may receive an email notification and a more traditional paper notification in the mail. Consumers that rank in the next decile may only receive an email notification.

The process described in FIG. 5 thus allows the issuer to more accurately identify consumers that may take advantage of an offer. As a result, the issuer is able to more efficiently use their resources to target the most promising consumers.

FIG. 6 is a flow chart illustrating a process according to an embodiment of the invention. More specifically, FIG. 6 illustrates a real-time process that can be used to identify events that may interest a consumer.

At step 610, a financial event occurs involving a consumer. For example, the financial event may be a transaction conducted by the consumer. As described in relation to FIG. 1, a transaction can be conducted in a variety of ways. For example, a consumer may use a portable consumer device to conduct a transaction with a merchant using an access device controlled by the merchant. Alternatively, the consumer may conduct a transaction over the Internet with an online merchant. According to some embodiments, financial events other than a transaction may be used to initiate the process illustrated in FIG. 6. For example, a new balance on a credit card, an increased credit limit on a credit card, an updated credit score, etc., may all be financial events that trigger the process illustrated in FIG. 6.

At step 620, transactional data, including transactional data from the financial event, is received. This step is similar to steps 520 and 410. For example, the transactional data may be the data that is being used to authorize an ongoing transaction occurring between a consumer and a merchant. The transactional data may include information not only identifying the consumer, the merchant, and the items being purchased, but the transactional data may include information that identifies where the transaction is taking place. For example, a consumer conducting a transaction to purchase high-end culinary equipment might include information identifying the pots and pans purchased, the amount of the transaction, as well as the location of the merchant. Other transactional data, such as the consumer's spending history, may also be received. For example, the consumer may have a history of purchasing imported wines.

At step 630, local non-transactional data is received. This step is similar to steps 530 and 420. According to various embodiments, the non-transactional data may be received before the financial event of step 610 so that the non-transactional data is ready to be used for the analysis. For example, the non-transactional data may reveal that a wine importer close to the culinary merchant is offering coupons on various French wines.

At step 640, the transactional data and non-transactional data are analyzed. This step is similar to steps 430 and 540. Returning to the example of the consumer conducting a culinary-related transaction, the probabilistic model may reveal that a consumer with a history of purchasing imported wines and in the process of conducting a culinary-related transaction has a high probability of taking advantage of wine promotions.

At step 650, similar to steps 440 and 560, further processing occurs. For example, a coupon may be sent to the consumer via SMS. Alternatively, a coupon may be printed out for the consumer using the access device of the merchant. Other processing may also occur to inform the consumer of the event at the wine importer.

At step 660, the financial event related to the consumer concludes. For example, the consumer may complete the transaction of the culinary equipment.

According to various embodiments, the use of keys, tumbler, locks, and other similar modules allow for the process illustrated in FIG. 6 to occur in real-time with the financial event. Additional details on how keys, tumblers, and locks can enable this type of real-time functionality can be found in U.S. Pat. No. 7,227,950.

III. Exemplary Consumer Devices, Access Devices, and Computer Apparatuses

FIG. 7(a) shows a block diagram of another phone 32′ that can be used in embodiments of the invention. The exemplary wireless phone 32′ may comprise a computer readable medium and a body as shown in FIG. 7(a). The computer readable medium 32(b) may be present within the body 32(h), or may be detachable from it. The body 32(h) may be in the form a plastic substrate, housing, or other structure. The computer readable medium 32(b) may be in the form of (or may be included in) a memory that stores data (e.g., issuer account numbers, loyalty provider account numbers, and other elements of split payment data) and may be in any suitable form including a magnetic stripe, a memory chip, etc. The memory preferably stores information such as financial information, transit information (e.g., as in a subway or train pass), access information (e.g., as in access badges), etc. Financial information may include information such as bank account information, loyalty account information (e.g., a loyalty account number), a bank identification number (BIN), credit or debit card number information, account balance information, expiration date, consumer information such as name, date of birth, etc. Any of this information may be transmitted by the phone 32′.

In some embodiments, information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The phone 32′ may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) phone 32′ and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the phone 32′ and an interrogation device. Thus, the phone 32′ is capable of communicating and transferring data and/or control instructions via both cellular network and near field communications capability.

The phone 32′ may also include a processor 32(c) (e.g., a microprocessor) for processing the functions of the phone 32 and a display 32(d) to allow a consumer to see phone numbers and other information and messages. The phone 32′ may further include input elements 32(e) to allow a consumer to input information into the device, a speaker 32(f) to allow the consumer to hear voice communication, music, etc., and a microphone 32(i) to allow the consumer to transmit her voice through the phone 32′. The phone 32′ may also include an antenna 32(a) for wireless data transfer (e.g., data transmission).

If the consumer device is in the form of a debit, credit, or smartcard, the consumer device may also optionally have features such as magnetic strips. Such devices can operate in either a contact or contactless mode.

An example of a consumer device 32″ in the form of a card is shown in FIG. 7(b). FIG. 7(b) shows a plastic substrate 32(m). A contactless element 32(o) for interfacing with an access device 34 may be present on or embedded within the plastic substrate 32(m). Consumer information 32(p) such as an account number, expiration date, and consumer name may be printed or embossed on the card. Also, a magnetic stripe 32(n) may also be on the plastic substrate 32(m).

As shown in FIG. 7(b), the consumer device 32″ may include both a magnetic stripe 32(n) and a contactless element 32(o). In other embodiments, both the magnetic stripe 32(n) and the contactless element 32(o) may be in the portable consumer device 32″. In other embodiments, either the magnetic stripe 32(n) or the contactless element 32(o) may be present in the portable consumer device 32″.

FIG. 8 shows a block diagram of an access device 34 according to an embodiment of the invention. The access device 34 comprises a processor 34(c) operatively coupled to a computer readable medium 34(d) (e.g., one or more memory chips, etc.), input elements 34(b) such as buttons or the like, a reader 34(a) (e.g., a contactless reader, a magnetic stripe reader, etc.), an output device 34(e) (e.g., a display, a speaker, etc.) and a network interface 34(f). The computer readable medium may comprise instructions or code, executable by a processor. The instructions may include instructions for sending a first authorization request message to a server computer, wherein the server computer thereafter receives a first authorization request message from a merchant and at a server computer, analyzes the first authorization request message using the server computer, sends a second authorization request message to a first service provider, sends a third authorization request message to a second service provider, receives a first response message from the first service provider, receives a second response message from the second service provider, and sends a third authorization response message; and receiving the third authorization response message.

The various participants and elements in FIG. 1 may operate one or more computer apparatuses (e.g., a server computer) to facilitate the functions described herein. Any of the elements in FIG. 1 may use any suitable number of subsystems to facilitate the functions described herein. Examples of such subsystems or components are shown in FIG. 9. The subsystems shown in FIG. 9 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

This application incorporates by reference for all purposes the entire contents of the following applications for all purposes; such applications can disclose features (e.g., risk prediction systems) that can be used in some aspects of embodiments of the invention:

(1) U.S. Pat. No. 6,119,103, issued Sep. 12, 2000, entitled “Financial Risk Prediction Systems and Methods Therefor;”

(2) U.S. Pat. No. 6,018,723, issued Jan. 25, 2000, entitled “Method and Apparatus for Pattern Generation;”

(3) U.S. Pat. No. 6,658,393, issued Dec. 2, 2003, entitled “Financial Risk Prediction Systems and Methods Therefor;”

(4) U.S. Pat. No. 6,598,030, issued Jul. 22, 2003, entitled “Method and Apparatus for Pattern Generation;” and

(5) U.S. Pat. No. 7,227,950, issued Jun. 5, 2007, entitled “Distributed Quantum Encrypted Pattern Generation and Scoring.”

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

In general, the steps associated with the various methods of the present invention may be widely varied. For instance, steps may be added, removed, reordered, and altered. As an example, the steps associated with receiving local non-transactional data at a server computer may involve, in one embodiment, subscribing to an RSS feed. Another embodiment may use a web crawler application to receive non-transactional data. Still many other means for receiving non-transactional data may also be used. Therefore, the present examples are to be considered as illustrative and not restrictive, and the invention is not to be limited to the details given herein, but may be modified within the scope of the appended claims.

A recitation of “a”, “an” or “the” is intended to mean “one or more” unless specifically indicated to the contrary.

One or more features from any embodiment may be combined with one or more features of any other embodiment without departing from the scope of the disclosure.

What is claimed is:

1. A method for using transactional data and local non-transactional data, the method comprising:
receiving transactional data at a server computer, wherein the transactional data relates to transactions conducted by a consumer;
receiving local non-transactional data at the server computer;
analyzing the transactional data and the local non-transactional data using the server computer; and
performing further processing after analyzing the transactional data and the local non-transactional data.

2. The method of claim 1 wherein at least some of the transaction data is received from an ongoing financial event with the consumer.

3. The method of claim 2 wherein the steps of receiving transactional data, analyzing the transaction data and the local non-transactional data, and performing further processing is done in substantially real-time with the ongoing financial event.

4. The method of claim 1 wherein the server computer is part of a payment processing system.

5. The method of claim 1 wherein the local non-transactional data includes information extracted from local newspapers, blogs, local event calendars, or message boards.

6. The method of claim 1 wherein the further processing comprises sending a coupon to the consumer.

7. The method of claim 1 wherein the further processing comprises sending a ticket to the consumer.

8. The method of claim 1 wherein the further processing comprises sending an offer to the consumer.

9. The method of claim 1 wherein the local non-transaction data relates to an event that occurs within 100 miles of where the consumer resides or works.

10. The method of claim 1 wherein the further processing comprises transmitting a notification of an event to the consumer.

11. A system for combining transactional data and local non-transactional data to take an action with a consumer, the system comprising:
a transactional data receiver, wherein the transactional data receiver is configured to receive transaction data relating to transactions conducted by a consumer;
a local data receiver, wherein the local data receiver is configured to receive local non-transactional data;
a data analyzing module, wherein the data analyzing module is configured to analyze transactional data received by the transactional data receiver with the local non-transactional data received at the local data receiver; and
an action initiating module, wherein the action initiating module is configured to perform further processing after the analysis of the transactional data and the local non-transactional data.

12. The system of claim 11 wherein the transactional data receiver receives transaction data from an ongoing financial event with the consumer.

13. The system of claim 12 wherein the data analyzer and the action initiator both conduct their actions in substantially real-time with the ongoing financial event with the consumer.

14. The system of claim 11 wherein the local non-transactional data includes information extracted from local newspapers, blogs, local event calendars, or message boards.

15. The system of claim 11 wherein the further processing conducted by the action initiator is the sending of a coupon to the consumer.

16. The system of claim 11 wherein the further processing conducted by the action initiator is the sending of a ticket to the consumer.

17. The system of claim 11 wherein the further processing conducted by the action initiator is the sending of an offer to the consumer.

18. The system of claim 11 wherein the further processing conducted by the action initiator is the sending of a notification to the consumer.

19. The system of claim 11 wherein the system is a part of a payment processing system.

20. A computer-readable medium comprising computer-executable code capable of directing a processor to carrying out the steps of claim 1.
